(19) United States
(12) Patent Application Publication
(10) Pub. No.: US 2003/0065646 A1
(43) Pub. Date: Apr. 3, 2003

(54) Database interface architecture with time-based load balancing in a real-time environment

(76) Inventors: Paul G. Joseph, Boxboro, MA (US); Sanjeev Nandan, Lawrence, MA (US); Sudarshan Purohit, Pune (IN); Trivikram Nayak, Pune (IN); A. B. Manikhandan, Pune (IN)

Correspondence Address: ROPES & GRAY, ONE INTERNATIONAL PLACE, BOSTON, MA, 02110-2624, US

(21) Appl. No.: 10/243,623

(22) Filed: Sep. 13, 2002

Related U.S. Application Data
(60) Provisional application No. 60/322,027, filed on Sep. 13, 2001.

(51) Int. Cl. G06F 7/00

(52) U.S. Cl. 707/1

(57) ABSTRACT

A database interface architecture is disclosed that operates in an asynchronous mode, provides for load balancing over time, and is optimized for high speed. Even when the system is under light load, data is inserted into the database in a timely manner by flushing the buffer after a configurable time interval, regardless of how full or empty the buffer is, thereby ensuring that data does not remain in the buffer during times of light or no load. The buffer can also be flushed by setting a flag whereby the buffer is flushed regardless of the timestamp on the buffer.

### CROSS-REFERENCE TO OTHER PATENT APPLICATIONS

This application claims the benefit of U.S. provisional application No. 60/322,027, filed Sep. 13, 2001, the content of which is incorporated herein in its entirety by reference.

### FIELD OF THE INVENTION

The invention is directed to a database interface architecture, and more particularly to a database interface architecture that operates in an asynchronous mode, provides for load balancing over time, and is optimized for high speed but which is also able to timely handle the application programs transaction requests to the database (inserts/updates/deletes) even under low load conditions.

### BACKGROUND OF THE INVENTION

In client-server environments that require access to a database, daemons are typically provided to handle the client's requests for services, or queries, as part of which the database may have to be updated, and/or records may have to be inserted in or deleted from the database. A daemon is commonly defined as a program that runs continuously and exists for the purpose of handling periodic service requests that a computer system expects to receive. The daemon program forwards the requests to other programs (or processes) as appropriate. Each server of pages on the Web has an HTTPD or Hypertext Transfer Protocol Daemon that continually waits for requests to come in from Web clients and their users.

It is known that under a high load, the applications serviced by daemons, which insert/update/delete the data in the database, can be slowed down and hence be unable to handle the load, with the result that an application is unable to provide the desired data processing throughput. For example, details of each page served by a web server may need to be inserted into the database. The thread that served the page would under normal circumstances be the one that performs the insert. When the insertion is done synchronously, the thread can be slowed down under high loads by the time taken to do the insertion, and under adverse circumstances, the thread may have to wait until other threads have completed their operations with the database.

Several methods have been proposed to correct these problems, such as multi-threading of the database server process, forking the database server process, prioritizing tasks (threads), and subdividing the database server process into multiple processes to service specific transaction requests. These approaches are generally done at the database level and do not change the way daemons handle the service requests.

To provide greater flexibility, asynchronous data transfer was proposed, wherein processes are executed independently “in the background”, and other processes may be started before the asynchronous process has finished. Here again, a system designed for a high load may not function properly under a low load condition and vice versa. For example, data may remain in an asynchronous buffer for too long under low load conditions.

It would therefore be desirable to provide a system and a method with an architecture that is optimized for fast and efficient handling of both low and high loads and with minimal thread locking. The architecture should allow a server to load-balance database interactions under high load conditions over time, while timely updating the database under low load conditions, with a minimum of computer resources.

### SUMMARY OF THE INVENTION

The system and method are directed to a database interface, and more particularly to a database interface that can operate efficiently under both high and low loads, where timely updating during periods of low activity is important. The system and method operate in an asynchronous mode and is optimized to utilize minimal computer resources.

According to one aspect of the invention, a method for load-dependent handling database transaction requests includes receiving a database transaction request from a client; placing the database transaction request in a buffer memory; transferring the database transaction requests residing in the buffer memory into an intermediate storage device in response to a load-dependent dependent transfer command supplied to the buffer memory; and transmitting from the intermediate storage device selected ones of the database transaction requests to a database for updating corresponding records in the database.

According to another aspect of the invention, a computer system for handling load-dependent database transaction requests includes a network interface receiving transaction requests from a client, a buffer memory receiving from the input port the transaction requests, an intermediate storage connected to the buffer memory, said buffer memory transferring the database transaction requests residing in the buffer memory into an intermediate storage device in response to a load-dependent transfer command supplied to the buffer memory, and a database interface for transmitting from the intermediate storage device selected ones of the database transaction requests to a database for updating corresponding records in the database.

According to still another aspect of the invention, a database server for handling database interactions between a client and a database over a network includes a network interface receiving records for a database interaction, a buffer memory for temporarily storing the received records, and at least one worker thread for handling transfer of the received records to the buffer memory. The database server further includes an intermediate storage device in data communication with the buffer memory, wherein the buffer memory transferring the temporarily stored records residing in the buffer memory into the intermediate storage device in response to a load-dependent transfer command supplied to the buffer memory. At least one database thread which is different from the at least one worker thread monitors the intermediately stored records in the intermediate storage device and, if a record in the database matches an intermediately stored record, processes the intermediately stored record for updating the matching record in the database.

According to yet another aspect of the invention, a computer system as well as a computer-readable medium storing a computer program executable by at least one server computer is described, wherein the computer program includes computer instructions for placing a database transaction request received from a client into a buffer memory; transferring the database transaction requests residing in the buffer memory into an intermediate storage device in response to a load-dependent transfer command supplied to the buffer memory; and transmitting from the intermediate storage device selected ones of the database transaction requests to a database for updating corresponding records in the database.

Embodiments of the invention may include one or several of the following features. The load-dependent transfer command can be supplied when an elapsed time since a previous transfer of database transactions from the buffer memory into the intermediate storage is greater than a predetermined time. Alternatively, the load-dependent transfer command can be supplied if the buffer memory is full when placing the database transaction request in the buffer memory. In particular situation, for example, when data traffic is low, the load-dependent transfer command can be supplied by a housekeeping thread or by a worker thread having “NULL” data.

A configurable number of worker threads can be provided to handle placing the database transaction requests in the buffer memory. Likewise, a configurable number of database threads can be provided to handle transmitting the selected database transaction requests from the intermediate storage device to the database. The database transaction requests can be read from the buffer memory either line-by-line, page by page or all at once (memory dump). Database threads can be configured so as to one of mark and delete a corresponding record in the intermediate storage device after updating the record in the database.

The buffer memory can be implemented as random access memory (RAM), whereas the intermediate storage may include various types of mass storage, such as magnetic and optical disks.

Further features and advantages of the present invention will be apparent from the following description of preferred embodiments and from the claims.

### BRIEF DESCRIPTION OF THE DRAWINGS

The following figures depict certain illustrative embodiments of the invention in which like reference numerals refer to like elements. These depicted embodiments are to be understood as illustrative of the invention and not as limiting in any way.

FIG. 1 shows schematically a database interface architecture with load balancing;

FIG. 2 is a schematic flow diagram of a load balancing process; and

FIG. 3 shows schematically a prior art database interface architecture.

### DETAILED DESCRIPTION OF CERTAIN ILLUSTRATED EMBODIMENTS

The systems and methods described herein are directed to, among other things, a database interface that provides for load balancing over time. In particular, the database interfaces described herein may operate in an asynchronous mode, may be optimized for high speed and high load, but also are able to timely handle the application programs requests to the database (inserts/updates/deletes) even under low load conditions.

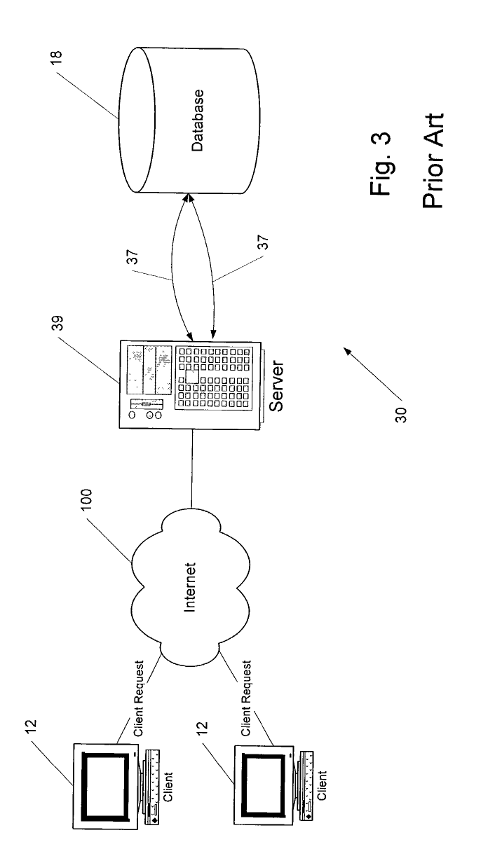

Reference is first made to FIG. 3, which depicts a prior art system 30 handling service requests from clients 12 for inserting/updating/deleting records in a database 18. The client or clients 12 typically first connect to a server 39 via a network, such as the Internet 100, using the server's 39 URL address, as is known in the art. Service requests can relate, for example, to online purchases on merchants' Web sites, online banking transactions, and the like. A user at the client terminal 12 would herein fill out a form in a browser window and send the completed form to the server 39, or request a completed form from the server 39 for modifications. Server 39 communicates with the database 18, with the communication handled by threads 37. The number of threads 37 is typically equal to the number of service requests. The communication between server 39 and database 18 in the prior art system 30 is conventional and follows a database protocol, such as the ODBC (Open DataBase Connectivity) standard, wherein an application can submit statements to ODBC which ODBC then translates into the protocol the database understands.

As already mentioned above, the database 18 network interface is only able to handle a specific, finite number of service requests, slowing down the system 30 under heavy load. Increasing the size, e.g., ports and memory, of the database network interface to accommodate peak data traffic may not be economical. It has therefore been found to be advantageous to decouple handling the actual service requests received from the clients 12 from the database interaction itself.

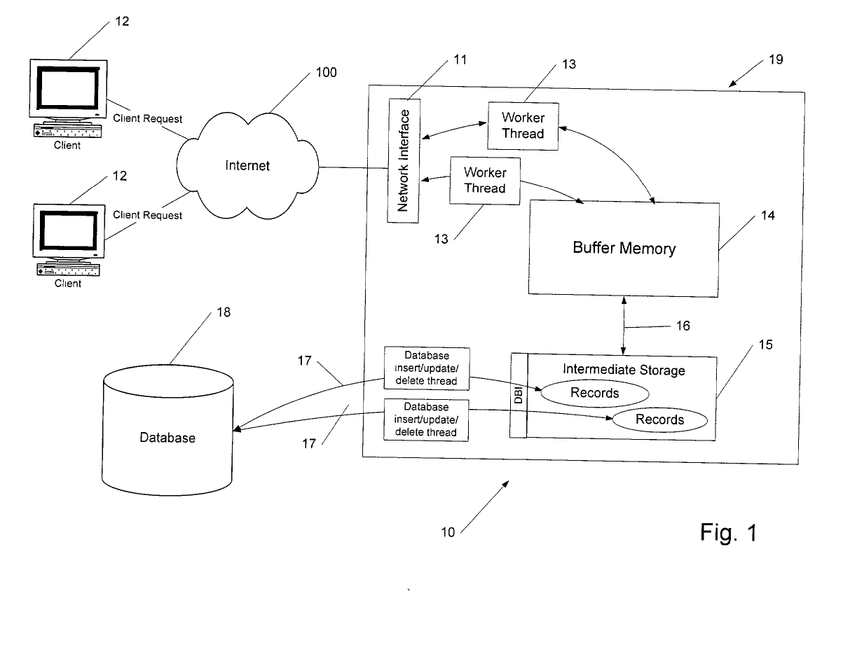

Referring now to FIG. 1, in an exemplary embodiment of a system 10 according to the invention, one or more clients 12 are connected via a network, such as the Internet 100, to one or more servers 19 (only one is shown) that interacts with one or more databases 18 (only one is shown). Exemplary server 19 includes at least a network interface 11 connected to the Internet 100, a buffer memory 14, and an intermediate storage device 15. The buffer memory 14 can be volatile memory, such as Random Access Memory (RAM). The intermediate storage device 15 cooperates with database 18 and is connected to buffer memory 14 via, for example, a data bus 16 to enable data transfer between buffer memory 14 and intermediate storage 15 in a manner to be described below. A database interface (DBI) provides connectivity between the server 19 and the database 18.

Unlike the conventional system 30 of FIG. 3, wherein service requests between clients 12 and the database 18 were handled by synchronous threads 37, the system 10 decouples the service requests received by network interface 11 of server 19 from the actual processing of these requests in the database 18.

When clients 12 send requests via network 100 to the server 19 which requires access to database 18, the requests received at the network interface 11 are queued and processed by a configurable number of worker threads 13. The number of worker threads can be configurable. Each worker thread 13 places the corresponding data into the buffer memory 14, also referred to as a cache. To prevent bottlenecks, the buffer memory 14 can be suitably sized to accommodate a large number of simultaneous service requests. Since buffer memory is typically implemented as a semiconductor RAM, it tends to be much more expensive than, for example, magnetic disk or optical disk memory. For this reason, data are transferred from buffer memory 14 to the intermediate storage device 15, such as magnetic or optical disk storage, which can have substantially more storage capacity than the buffer memory 14. The buffer memory 14 can be written to the intermediate storage 15 either by reading the buffer memory 14 line-by-line and outputting the read lines line-by-line to the intermediate storage 15. Alternatively, the entire buffer memory 14 can be read at once and dumped into the intermediate storage 15 with one or more buffered writes.

If when processing a new record under normal to heavy load, a worker thread 13 finds that the buffer memory 14 is full, then the entire data contents of the buffer 14 is swapped out to the intermediate storage 15, emptying the buffer memory 14 in the process, and the just processed new record is placed by one of the worker threads 13 into the now empty buffer memory 14. Depending on the design, emptying the buffer memory 14 can be initiated by the worker threads 13, or by a separate housekeeper thread if such housekeeper threads exist in the system to handle miscellaneous housekeeping type tasks. Once initiated, the actual process of emptying the buffer memory 14 can be carried out either by the worker threads 13 or by a suitable flush operation associated with the buffer memory itself. Such flush operation is similar to a “Fast Save” command in application programs running under the Windows® operating system. The buffer memory 14 will fill up quickly under normal to heavy load and can therefore also to be expected to empty in a timely and frequently fashion under normal to heavy load.

However, the buffer memory 14 has to be managed more carefully when the server 19 operates under a light load, i.e., it receives few client transaction requests. Without additional measures, the worker threads 13 can rarely expect to find the buffer memory 14 full and would hence not initiate a timely data transfer from the buffer memory 14 to the intermediate storage 15, as described above. Unless instructed by the housekeeper thread or by, for example, a flush command, the buffer memory 14 would simply keep accumulating transactions requests from the worker threads 13.

To ensure that data does not remain in the buffer memory 14 during times of light or no load, the buffer memory 14 can have a time stamp associated with it that reflects the last time the buffer memory 14 was updated. If the difference in time between this time stamp and the current time exceeds a configurable time interval, then the buffer memory 14 is flushed regardless of how full or empty it is. This difference in time can be checked, for example, by a worker thread 13 interacting with the buffer memory 14. However, no worker thread 13 would be available to check the difference in time, if no new data are received at the network interface 11. In this case, instead of using a timestamp at times of low load, a flag can be set to indicate that the buffer memory 14 be flushed. Alternatively or in addition, a worker thread 13 could be sent a “NULL” (no data), prompting the worker thread 13 to flush (or initiate the flush of) the buffer memory 14, regardless of the timestamp on the buffer memory.

Memory access intensive applications that use large amounts of virtual memory may obtain performance improvements by using large pages. The page size can be specified by the application, or a page size can selected based on the operating system. The size of the buffer memory 14 is hence made configurable, so that emptying the buffer memory 14 can be optimized for the application or the operating system characteristic. The format of the data written to and read/dumped from the buffer memory 14 can be any of several formats, such as ASCII, binary etc., depending on the specific application.

A separate database thread or set of database threads 17 continuously monitors the records in the intermediate storage 15 that have been transferred from the buffer memory 14. Like the number of worker threads 13 described above, the number of database threads 17 can also be also configurable. If a desired record is found in the intermediate storage 15, the database thread(s) 17 process(es) the data in this record, and appropriately insert(s) the data from this record into the database 18, update(s) the data in the database 18 with the data from this record, or delete(s) the data from the database 18. The database threads 17 operate independently and asynchronously from the worker threads 13, so that bottlenecks in the database access do not affect the interaction between the clients 12 and the server 19.

In some scenarios, a database thread 17 may have to perform more than one database interaction on each data (record) in a file. Thus for one application, a record is provided with a key field and a lookup is done for each record on a key field. If the lookup value for that key field is found, then the lookup value is appended to the record and another database transaction is done with the appended/extended record. If no lookup value is found, then the record is dropped and the database transaction for this record is skipped. Database transactions and other processing can hence be chained when performing the workflow operations on the data in the intermediate storage 15, filtering out data that do not meet desired criteria at each stage of the processing.

If for some reason the database 18 has gone down or the connection between the threads 17 and the database 18 is lost, then the threads 17 can be configured to keep trying to reconnect to the database 18 and to continue processing any unprocessed data in intermediate storage 15. Once the intermediate storage 15 is processed into the database 18, the records in the intermediate storage 15 can be either deleted or written to a log/record-keeping file.

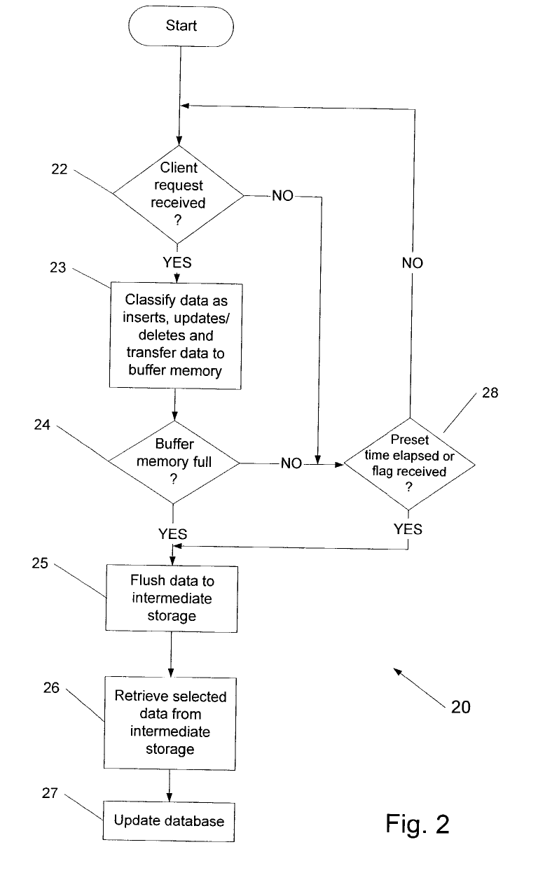

FIG. 2 shows an exemplary schematic flow diagram illustrating an exemplary time-based load-balancing process 20. Process 20 checks first if a request for a database access from a client 12 was received at the server 19, step 22. If such request was received, a worker thread can check the data and classify them as database inserts, updates and/or deletes, step 23. In step 24, the worker thread checks if the buffer memory 14 is full. If the buffer memory is full, then the worker thread initiates an automatic data flush from the buffer memory to the intermediate storage, step 25.

Conversely, if step 24 determines that the buffer is not full, then the worker thread checks in step 28 if a preset time has elapsed since the last flush of the buffer memory. If this is the case, then the worker thread, as before, causes the content of the buffer memory to be transferred in a manner described above into the intermediate storage. However, if step 28 determines that the preset time has not yet elapsed, or that no flag has been set and no other command has been given (such as from a housekeeper thread and/or a “NULL” worker thread), the process 20 returns to step 22 to accept additional requests from clients 12.

If a preset time has elapsed or a flag was set, then the process 20 goes to step 25 to initiate an automatic data flush from the buffer memory to the intermediate storage. As seen from FIG. 2, if no client requests are received and a preset time has elapsed since the buffer memory was flushed last, the process 20 goes immediately to step 25.

Records transferred in step 25 from the buffer memory 14 to the intermediate storage 15 can be retrieved by the database threads 17 from the intermediate storage, step 26, to insert/update these records in the database or delete these records from the database, step 27.

The proposed database interface architecture and method described above can timely handle client requests under both heavy and light load at high speed. In particular, requests can be timely handled even under low load conditions.

The process executing on one of the clients 12 and in response to a request from a user, transmitting a transaction request can be implemented as a Web document, such as an HTTP object that includes plain text (ASCII) conforming to the HyperText Markup Language (“HTML”). Other markup languages are known and may be used on appropriately enabled browsers and servers, including the Dynamic HyperText Markup Language (“DHTML”), the Extensible Markup Language (“XML”), the Extensible Hypertext Markup Language (“XHML”), and the Standard Generalized Markup Language (“SGML”). Documents and data can have any format that a daemon (also referred to as “Service” in Windows®) is to enter into a database, which can also be a proprietary format negotiated between the client 12 and the server 19.

An exemplary client 12 includes the conventional components of a client system, such as a processor, a memory (e.g. RAM), a bus which couples the processor and the memory, a mass storage device (e.g. a magnetic hard disk or an optical storage disk) coupled to the processor and the memory through an I/O controller, and a network interface coupled to the processor and the memory, such as modem, digital subscriber line (“DSL”) card, cable modem, network interface card, wireless network card, or other interface device capable of wired, fiber optic, or wireless data communications. One example of such a client 12 is a personal computer equipped with an operating system such as Microsoft Windows XP, Microsoft Windows NT, Unix, Linux, and

Linux variants, along with software support for Internet communication protocols. The personal computer may also include a browser program, such as Microsoft Internet Explorer or Netscape Navigator, to provide a user interface for access to the Internet 100. Although the personal computer is a typical client 12, the client 12 may also be a workstation, a mobile computer, a Web phone, a television set-top box, an interactive kiosk, a personal digital assistant, or another device capable of communicating over the data network 100.

The database 18 can be separate from the server 19 and may be located remote from the server. Servers may be clustered together to handle more client traffic, and may include separate servers for different functions such as a database server, a file server, an application server, and a Web presentation server. Such servers may further include one or more mass storage devices such as a disk farm or a redundant array of independent disk (“RAID”) system for additional storage and data integrity. Read-only devices, such as compact disk drives and digital versatile disk drives, may also be connected to the servers. Suitable servers and mass storage devices are manufactured by, for example, Compaq, IBM, and Sun Microsystems.

In one embodiment, the network 100 is the Internet, and the World Wide Web provides a system for interconnecting clients 12 and servers 19 through the Internet 100. The network 100 may alternatively or in addition include a cable network, a wireless network, and any other networks for interconnecting clients, servers and other devices, such as wide area networks (WAN) and local area networks (LAN).

While the invention has been disclosed in connection with the preferred embodiments shown and described in detail, various modifications and improvements thereon will become readily apparent to those skilled in the art. For example, the number of worker threads 13 and/or database threads 17 can be configurable and multiple servers can be connected to a single database, as described above, or to multiple databases . Accordingly, the spirit and scope of the present invention is to be limited only by the following claims.

We claim:

1. A method for load-dependent handling database transaction requests comprising:
receiving a database transaction request from a client;
placing said database transaction request in a buffer memory;
transferring the database transaction requests residing in the buffer memory into an intermediate storage device in response to a load-dependent transfer command supplied to the buffer memory; and
transmitting from the intermediate storage device selected ones of the database transaction requests to a database for updating corresponding records in the database.

2. The method of claim 1, wherein said load-dependent transfer command is supplied when an elapsed time since a previous transfer of database transactions from the buffer memory into the intermediate storage is greater than a predetermined time.

3. The method of claim 1, wherein said load-dependent transfer command is supplied if the buffer memory is full when placing said database transaction request in the buffer memory.

4. The method of claim 1, wherein said load-dependent transfer command is supplied by a housekeeping thread.

5. The method of claim 1, and further providing a configurable number of worker threads that handle placing the database transaction requests in the buffer memory.

6. The method of claim 5, wherein said load-dependent transfer command is supplied by a worker thread having NULL data.

7. The method of claim 1, and further providing a configurable number of database threads that handle transmitting the selected database transaction requests from the intermediate storage device to the database.

8. The method of claim 1, wherein transferring the database transaction requests further includes reading the database transaction requests from the buffer memory line-by-line.

9. The method of claim 1, wherein transferring the database transaction requests further includes reading the database transaction requests from the buffer memory all at once.

10. The method of claim 7, and further including configuring a database thread so as to one of mark and delete a corresponding record in the intermediate storage device after updating the record in the database.

11. A computer system for handling load-dependent database transaction requests, comprising
a network interface receiving transaction requests from a client;
a buffer memory receiving from the input port the transaction requests;
an intermediate storage connected to the buffer memory, said buffer memory transferring the database transaction requests residing in the buffer memory into an intermediate storage device in response to a load-dependent transfer command supplied to the buffer memory; and
a database interface for transmitting from the intermediate storage device selected ones of the database transaction requests to a database for updating corresponding records in the database.

12. The computer system of claim 11, wherein the buffer memory comprises a random access memory (RAM) and the intermediate storage comprises a disk storage.

13. A database server for handling database interactions between a client and a database over a network, comprising:
a network interface receiving records for a database interaction,
a buffer memory for temporarily storing the received records,
at least one worker thread for handling transfer of the received records to the buffer memory,
an intermediate storage device in data communication with the buffer memory, said buffer memory transferring the temporarily stored records residing in the buffer memory into the intermediate storage device in response to a load-dependent transfer command supplied to the buffer memory; and
at least one database thread different from the at least one worker thread, said at least one database thread monitoring the intermediately stored records in the intermediate storage device and, if a record in the database matches an intermediately stored record, processing the intermediately stored record for updating the matching record in the database.

14. The server of claim 13, wherein said load-dependent transfer command is supplied when a worker thread determines that an elapsed time since a previous transfer of records from the buffer memory into the intermediate storage is greater than a predetermined time.

15. The server of claim 13, wherein said load-dependent transfer command is supplied when a worker thread determines that the buffer memory is full when transferring said record into the buffer memory.

16. The server of claim 13, wherein said load-dependent transfer command is supplied by a housekeeping thread separate from a worker thread.

17. The server of claim 13, wherein said load-dependent transfer command is supplied by a worker thread having NULL data.

18. The server of claim 13, wherein said at least one database thread after updating marks in or deletes from the intermediate storage device the record that matches the record in the database.

19. A computer system for handling load-dependent database transaction requests, comprising computer instructions for:
placing a database transaction request received from a client into a buffer memory;
transferring the database transaction requests residing in the buffer memory into an intermediate storage device in response to a load-dependent transfer command supplied to the buffer memory; and
transmitting from the intermediate storage device selected ones of the database transaction requests to a database for updating corresponding records in the database.

20. A computer-readable medium storing a computer program executable by at least one server computer, the computer program comprising computer instructions for:
placing a database transaction request received from a client into a buffer memory;
transferring the database transaction requests residing in the buffer memory into an intermediate storage device in response to a load-dependent transfer command supplied to the buffer memory; and
transmitting from the intermediate storage device selected ones of the database transaction requests to a database for updating corresponding records in the database.
